(19) United States
(12) Patent Application Publication
(10) Pub. No.: US 2020/0282773 A1
(43) Pub. Date: Sep. 10, 2020

(54) Crown Reinforcement for a Tire for a Heavy Vehicle of Construction Plant Type

(71) Applicant: COMPAGNIE GENERAL DES ETABLISSEMENTS MICHELIN, Clermont-Ferrand (FR)

(72) Inventors: Alain DOMINGO, Clermont-Ferrand Cedex 9 (FR); Emmanuel CLEMENT, Clermont-Ferrand Cedex 9 (FR)

(21) Appl. No.: 16/648,969

(22) PCT Filed: Sep. 19, 2018
(86) PCT No.: PCT/FR2018/052286

§ 371 Date: Mar. 19, 2020

(30) Foreign Application Priority Data
Sep. 22, 2017 (FR) 1758770

(51) Int. Cl. B60C 9/00; B60C 9/20

(52) U.S. Cl. CPC B60C 9/0007; B60C 9/20; B60C 2009/0078; B60C 2009/0085; B60C 2009/0092; B60C 2200/065

(57) ABSTRACT

A radial tire for a heavy vehicle of construction plant type, and aims to increase the resistance of the crown thereof to attack The tire (1) for a heavy vehicle of construction plant type has a crown reinforcement (3) radially on the inside of a tread (2) and radially on the outside of a carcass reinforcement (4), the crown reinforcement (3) has, radially from the outside to the inside, a protective reinforcement (5) and a working reinforcement (6). The protective reinforcement (5) has at least one protective layer (51, 52) comprising elastic metal reinforcers that have a breaking strength Fm and a section of diameter D and are spaced apart in pairs by a spacing P at least equal to the diameter D. According to the invention, the ratio A=(P−D)/D is at least equal to 0.25 and at most equal to 1, the ratio B=(Fm/P)/1000 is at least equal to 1.1 and at most equal to 2, Fm being expressed in N and P being expressed in mm, and the elastic metal reinforcers of the protective layer (51, 52) are multistrand ropes of structure 1×N comprising a single layer of N strands wound in a helix.

The subject of the present invention is a radial tire, intended to be fitted to a heavy vehicle of construction plant type, and the invention relates more particularly to the crown reinforcement of such a tire.

Typically, a radial tire for a heavy vehicle of construction plant type, within the meaning of the European Tire and Rim Technical Organisation or ETRTO standard, is intended to be mounted on a rim with a diameter at least equal to 25 inches. Although not limited to this type of application, the invention is described for a radial tire of large size, intended to be mounted on a dumper, a vehicle for transporting materials extracted from quarries or open-cast mines, by way of a rim with a diameter at least equal to 49 inches, possibly as much as 57 inches, or even 63 inches.

Since a tire has a geometry that exhibits symmetry of revolution about an axis of rotation, the geometry of the tire is generally described in a meridian plane containing the axis of rotation of the tire. For a given meridian plane, the radial, axial and circumferential directions denote the directions perpendicular to the axis of rotation of the tire, parallel to the axis of rotation of the tire and perpendicular to the meridian plane, respectively. The circumferential direction is tangential to the circumference of the tire.

In the following text, the expressions “radially inner/radially on the inside” and “radially outer/radially on the outside” mean “closer to” and “further away from the axis of rotation of the tire”, respectively. “Axially inner/axially on the inside” and “axially outer/axially on the outside” mean “closer to” and “further away from the equatorial plane of the tire”, respectively, the equatorial plane of the tire being the plane passing through the middle of the tread surface and perpendicular to the axis of rotation.

Generally, a tire comprises a tread intended to come into contact with the ground via a tread surface, the two axial ends of which are connected via two sidewalls to two beads that provide the mechanical connection between the tire and the rim on which it is intended to be mounted.

A radial tire also comprises a reinforcement made up of a crown reinforcement radially on the inside of the tread and a carcass reinforcement radially on the inside of the crown reinforcement.

The carcass reinforcement of a radial tire for a heavy vehicle of construction plant type usually comprises at least one carcass layer comprising generally metal reinforcers coated in a polymeric material of the elastomer or elastomeric type known as a coating compound. A carcass layer comprises a main part that joins the two beads together and is generally wound, in each bead, from the inside of the tire to the outside around a usually metal circumferential reinforcing element known as a bead wire so as to form a turn-up. The metal reinforcers of a carcass layer are substantially mutually parallel and form an angle of between 85° and 95° with the circumferential direction.

The crown reinforcement of a radial tire for a heavy vehicle of construction plant type comprises a superposition of circumferentially extending crown layers radially on the outside of the carcass reinforcement. Each crown layer is made up of generally metal reinforcers that are mutually parallel and coated in a polymeric material of the elastomer or coating compound type.

Among the crown layers, a distinction is usually made between the protective layers, which make up the protective reinforcement and are radially outermost, and the working layers, which make up the working reinforcement and are radially comprised between the protective reinforcement and the carcass reinforcement.

The protective reinforcement, comprising at least one protective layer, essentially protects the working layers from mechanical or physicochemical attack, likely to spread through the tread radially towards the inside of the tire.

The protective reinforcement often comprises two protective layers, which are radially superposed, are formed of elastic metal reinforcers, are mutually parallel in each layer and are crossed from one layer to the next, forming angles at least equal to 10° and at most equal to 35°, and preferably at least equal to 15° and at most equal to 30°, with the circumferential direction.

The working reinforcement, comprising at least two working layers, has the function of belting the tire and conferring stiffness and road holding thereon. It absorbs both mechanical stresses of inflation, which are generated by the tire inflation pressure and transmitted by the carcass reinforcement, and mechanical stresses caused by running, which are generated as the tire runs over the ground and are transmitted by the tread. It is also intended to withstand oxidation and impacts and puncturing, by virtue of its intrinsic design and that of the protective reinforcement.

The working reinforcement usually comprises two working layers, which are radially superposed, are formed of inextensible metal reinforcers, are mutually parallel in each layer and are crossed from one layer to the next, forming angles at most equal to 60°, and preferably at least equal to 15° and at most equal to 45°, with the circumferential direction.

In order to reduce the mechanical stresses of inflation that are transmitted to the working reinforcement, it is known to dispose a hoop reinforcement radially on the inside of the working reinforcement and radially on the outside of the carcass reinforcement. The hoop reinforcement, the function of which is to at least partially absorb the mechanical stresses of inflation, improves the endurance of the crown reinforcement by stiffening the crown reinforcement. The hoop reinforcement can also be positioned radially between two working layers of the working reinforcement, or radially on the outside of the working reinforcement.

The hoop reinforcement usually comprises two hooping layers, which are radially superposed, are formed of metal reinforcers, are mutually parallel in each layer and are crossed from one layer to the next, forming angles at most equal to 10°, and preferably at least equal to 6° and at most equal to 8°, with the circumferential direction.

As regards the metal reinforcers, a metal reinforcer is characterized mechanically by a curve representing the tensile force (in N) applied to the metal reinforcer as a function of the relative elongation (in %) thereof, known as the force-elongation curve. Mechanical tensile characteristics of the metal reinforcer, such as the structural elongation As (in %), the total elongation at break At (in %), the force at break Fm (maximum load in N) and the breaking strength Rm (in MPa) are derived from this force-elongation curve, these characteristics being measured in accordance with the standard ISO 6892 of 1984.

The total elongation at break At of the metal reinforcer is, by definition, the sum of the structural, elastic and plastic elongations thereof (At=As+Ae+Ap). The structural elongation As results from the relative positioning of the metal threads making up the metal reinforcer under a low tensile force. The elastic elongation Ae results from the actual elasticity of the metal of the metal threads making up the metal reinforcer, taken individually, the behaviour of the metal following Hooke's law. The plastic elongation Ap results from the plasticity, i.e. the irreversible deformation beyond the yield point, of the metal of these metal threads taken individually. These different elongations and the respective meanings thereof, which are well known to a person skilled in the art, are described for example in the documents U.S. Pat. No. 5,843,583, WO2005/014925 and WO2007/090603.

Also defined, at any point on the force-elongation curve of a metal reinforcer, is a tensile modulus, expressed in GPa, which represents the gradient of the straight line tangential to the force-elongation curve at this point. In particular, the tensile modulus of the elastic linear part of the force-elongation curve is referred to as the elastic tensile modulus or Young's modulus.

Among the metal reinforcers, a distinction is usually made between the elastic metal reinforcers, such as the ones used in the protective layers, and the inextensible metal reinforcers, such as the ones used in the working layers.

An elastic metal reinforcer is characterized by a structural elongation As at least equal to 1% and a total elongation at break At at least equal to 4%. Moreover, an elastic metal reinforcer has an elastic tensile modulus at most equal to 150 GPa, and usually between 40 GPa and 150 GPa.

An inextensible metal reinforcer is characterized by a total elongation At, under a tensile force equal to 10% of the force at break Fm, at most equal to 0.2%. Moreover, an inextensible metal reinforcer has an elastic tensile modulus usually between 150 GPa and 200 GPa.

The inventors have observed that, when rolling over more or less sharp stones present on the tracks along which dumpers travel, the tread of a tire is frequently subject to cuts that are likely to pass through it radially towards the inside as far as the protective reinforcement. These cuts to the tread bring about local corrosion of the metal reinforcers of the radially outer protective layer, this corrosion being likely to spread in said protective layer, to cause detachment of the tread, and to bring about chunking of tread portions.

The inventors have set themselves the objective of increasing the resistance of the crown of a radial tire for a heavy vehicle of construction plant type to attack, such as cuts to the tread, via a suitable choice of the design parameters of the protective layers.

This objective has been achieved, according to the invention, by a tire for a heavy vehicle of construction plant type, comprising a crown reinforcement radially on the inside of a tread and radially on the outside of a carcass reinforcement,
the crown reinforcement comprising, radially from the outside to the inside, a protective reinforcement and a working reinforcement,
the protective reinforcement comprising at least one protective layer comprising metal reinforcers that are coated in an elastomeric material, are mutually parallel and form an angle at least equal to 10° with a circumferential direction tangential to the circumference of the tire,
the metal reinforcers of the protective layer each having a section of diameter D and being spaced apart in pairs by a spacing P at least equal to the diameter D,
the metal reinforcers of the protective layer being elastic and having a breaking strength Fm,
the ratio A=(P−D)/D being at least equal to 0.25 and at most equal to 1,
the ratio B=(Fm/P)/1000 being at least equal to 1.1 and at most equal to 2, Fm being expressed in N and P being expressed in mm,
and the elastic metal reinforcers of the protective layer being multistrand ropes of structure 1×N comprising a single layer of N strands wound in a helix, each strand comprising an internal layer of M internal threads wound in a helix and an external layer of K external threads wound in a helix around the internal layer.

The diameter D of the section of a reinforcer is the diameter of the circle circumscribed on the section of the reinforcer, measured in a meridian cross section of the tire, that is to say a tire section on a meridian plane. The spacing P between two consecutive reinforcers is the distance measured between the centres of the circles circumscribed on the respective sections of two consecutive reinforcers, measured in a meridian cross section of the tire. Consequently, the distance (P−D) is the distance between two consecutive reinforcers, or, more specifically, the distance between the circles circumscribed on the respective sections of two consecutive reinforcers. In the following text, the distance (P−D) is referred to as the inter-reinforcer distance. Moreover, the distance (P−D) corresponds to the portion of elastomeric material between two consecutive reinforcers, sometimes referred to as rubber bridge. Therefore, the ratio A=(P−D)/D is the relative distance between two consecutive reinforcers corrected for the diameter D of a reinforcer.

A ratio A=(P−D)/D at least equal to 0.25 means that the distance between two consecutive reinforcers has to be at least equal to a minimum value equal to 25% of the diameter D. This first condition means that two consecutive reinforcers cannot be in contact with one another. Below this value, two consecutive reinforcers are very close to one another, or likely to be in contact with one another: hence, there is a high risk of the corrosion spreading from one reinforcer to the other.

A ratio A=(P−D)/D at most equal to 1 means that the distance between two consecutive reinforcers has to be at most equal to a maximum value equal to 100% of the diameter D. This second condition aims for there not to be too great a distance between two consecutive reinforcers. Above this value, there is a high risk of there being cracks passing through the protective reinforcement, between two consecutive reinforcements, radially towards the inside as far as the working reinforcement. In addition, the density of reinforcers then becomes too low to ensure the force at break required for a protective layer.

The ratio Fm/P represents the force at break of an individual portion of protective layer, comprising metal reinforcers that have a force at break Fm and are spaced apart by a spacing P. If Fm is expressed in N and P in mm, the ratio Fm/P in N/mm is the force at break of an individual portion of protective layer with a width equal to 1 mm. The ratio B=(Fm/P)/1000, equal to the ratio Fm/P divided by 1000, is therefore a coefficient of force at break of an individual portion of protective layer. Such a ratio B is defined conventionally so as to have ratios A and B of the same order of magnitude.

A ratio B=(Fm/P)/1000 at least equal to 1.1 and at most equal to 2 means that the force at break of an individual portion of protective layer has to be between 1100 N/mm and 2000 N/mm.

The inventors have found that the spreading of the corrosion in the metal reinforcers of the radially outer protective layer, resulting from cracking of the tread as a result of cutting, is all the greater the closer the inter-reinforcer distance is to 0, that is to say the closer these reinforcers are to touching. In order to limit the spreading of the corrosion, it is therefore advantageous to increase the inter-reinforcer distance. Another advantage of an increased inter-reinforcer distance is that there is a wider rubber bridge, and therefore an improvement in the connection between the tread and the radially outer protective layer, and consequently a reduction in the risk of cracking at this interface and the risk of chunking of tread portions. On the other hand, the inter-reinforcer distance should not be too large so as not to increase the risk of spreading of cracks, initiated in the tread, through the protective reinforcement to the working reinforcement, and, correspondingly, so as not to increase the risk of puncturing or cutting of the working layers. The inventors have shown that a ratio A=(P−D)/D at least equal to 0.25 and at most equal to 1 was a good compromise for an optimal inter-reinforcer distance for a reinforcer of given diameter D.

Furthermore, an increased inter-reinforcer distance involves a reduction in the density of reinforcers, and thus a reduction in the force at break of an individual portion of protective layer. Therefore, it is advantageous to increase the diameter D of the reinforcers and to have a higher reinforcer breaking strength Fm. The inventors have shown that a ratio B=(Fm/P)/1000 at least equal to 1.1 and at most equal to 2 was particularly advantageous.

Still according to the invention, the elastic metal reinforcers of the protective layer are multistrand ropes of structure 1×N comprising a single layer of N strands wound in a helix, each strand comprising an internal layer of M internal threads wound in a helix and an external layer of K external threads wound in a helix around the internal layer.

Advantageously, the ratio A=(P−D)/D is at least equal to 0.3.

According to a preferred embodiment of the protective layers, the diameter D is at least equal to 3 mm, the force at break Fm is at least equal to 5900 N, and the spacing P is at least equal to 4 mm.

According to a first variant of the preferred embodiment of the multistrand ropes, N=3 or N=4, preferably N=4.

According to a second variant of the preferred embodiment of the multistrand ropes, M=3, 4 or 5, preferably M=3.

According to a third variant of the preferred embodiment of the multistrand ropes, K=7, 8, 9, 10 or 11, preferably K=8.

A preferred example of a multistrand rope for a protective layer according to the invention has a structure of 4*(3+8).35 or 44.35. It is a multistrand rope having N=4 strands, each strand comprising an internal layer of M=3 internal threads wound in a helix and an external layer of K=8 external threads wound in a helix around the internal layer, the threads having a section of diameter d=0.35 mm.

Advantageously, the metal reinforcers of the protective layer form an angle at least equal to 15° and at most equal to 35° with the circumferential direction.

Preferably, the protective reinforcement comprises two protective layers, the respective metal reinforcers of which are crossed from one protective layer to the next.

Further preferably, the working reinforcement comprises two working layers, the respective metal reinforcers of which, which are inextensible, are coated in an elastomeric material, are mutually parallel and form an angle at least equal to 15° and at most equal to 45° with the circumferential direction, are crossed from one working layer to the next.

The crown reinforcement advantageously comprises, radially on the inside of the working reinforcement, a hoop reinforcement comprising two hooping layers, the respective metal reinforcers of which, which are coated in an elastomeric material, are mutually parallel and form an angle at most equal to 10° with the circumferential direction, are crossed from one hooping layer to the next.

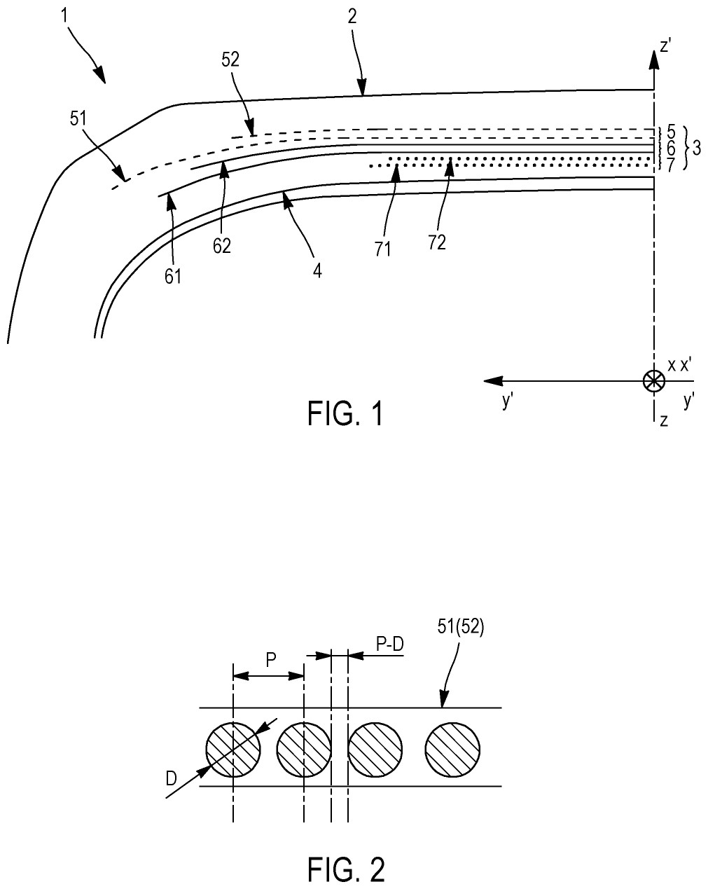

The features of the invention are illustrated in the schematic FIGS. 1 and 2, which are not to scale, with reference to a tire of size 40.00R57:

FIG. 1 is a meridian cross section through a crown of a tire for a heavy vehicle of dumper type according to the invention

FIG. 2 is a meridian cross section through a portion of protective layer according to the invention

FIG. 1 shows a meridian cross section through a tire 1 for a heavy vehicle of construction plant type of size 40.00R57, comprising a crown reinforcement 3 radially on the inside of a tread 2 and radially on the outside of a carcass reinforcement 4. The crown reinforcement 3 comprises, radially from the outside to the inside, a protective reinforcement 5, a working reinforcement 6 and a hoop reinforcement 7. The protective reinforcement 5 comprises two protective layers (51, 52) comprising metal reinforcers that are coated in an elastomeric material, are mutually parallel and form an angle equal to 24° with a circumferential direction XX′ tangential to the circumference of the tire, the respective metal reinforcers of each protective layer being crossed from one protective layer to the next. The working reinforcement 6 comprises two working layers (61, 62), the respective metal reinforcers of which, which are inextensible, are coated in an elastomeric material, are mutually parallel and form angles respectively equal to 33° and 19° with the circumferential direction XX′, are crossed from one working layer to the next. The hoop reinforcement 7 comprises two hooping layers (71, 72), the respective metal reinforcers of which, which are coated in an elastomeric material, are mutually parallel and form an angle of between 6° and 8° with the circumferential direction XX′, are crossed from one hooping layer to the next.

FIG. 2 shows a meridian cross section through a portion of protective layer (51, 52). The metal reinforcers of the protective layer (51, 52) each have a section of diameter D and are spaced apart in pairs by a spacing P at least equal to the diameter D. The inter-reinforcer distance between two consecutive reinforcers is P−D. Moreover, the metal reinforcers of the protective layer (51, 52) are elastic and have a breaking strength Fm.

Two types of metal reinforcers of the protective layer (51, 52) were studied in more detail: a multistrand rope of structure 52.26 and a multistrand rope of structure 44.35. The rope 52.26 is a multistrand rope having N=4 strands, each strand comprising an internal layer of M=4 internal threads wound in a helix and an external layer of K=9 external threads wound in a helix around the internal layer, the threads having a section of diameter d=0.26 mm. The rope 44.35 is a multistrand rope having N=4 strands, each strand comprising an internal layer of M=3 internal threads wound in a helix and an external layer of K=8 external threads wound in a helix around the internal layer, the threads having a section of diameter d=0.35 mm.

Table 1 presents the respective changes in the ratio A=(P−D)/D and the ratio B=(Fm/P)/1000 as a function of the spacing P, for an elastic metal multistrand rope of structure 52.26 having a diameter D=3.1 mm and a force at break Fm=5950 N.

TABLE 1

| P (mm) | 3.15 | 3.5 | 3.7 | 4.1 | 4.4 | 4.8 | 5 | 5.5 | 6 | 6.5 |
|---|---|---|---|---|---|---|---|---|---|---|
| A = (P − D)/D | 0.02 | 0.13 | 0.19 | 0.32 | 0.42 | 0.55 | 0.61 | 0.77 | 0.94 | 1.10 |
| B = (Fm/P)/1000 | 1.9 | 1.7 | 1.6 | 1.45 | 1.4 | 1.2 | 1.2 | 1.1 | 1.0 | 0.9 |

For an elastic metal multistrand rope of structure 52.26 having a diameter D=3.1 mm and a force at break Fm=5950 N, values of the spacing P of between 4.1 mm and 5.5 mm ensure that the essential features of the invention are complied with.

Table 2 presents the respective changes in the ratio A=(P−D)/D and the ratio B=(Fm/P)/1000 as a function of the spacing P, for an elastic metal multistrand rope of structure 44.35 having a diameter D=3.8 mm and a force at break Fm=9500 N.

TABLE 2

| P (mm) | 3.8 | 4.4 | 4.8 | 5 | 5.5 | 6 | 6.5 |
|---|---|---|---|---|---|---|---|
| A = (P − D)/D | 0 | 0.15 | 0.26 | 0.31 | 0.44 | 0.57 | 0.71 |
| B = (Fm/P)/1000 | 2.5 | 2.2 | 2.0 | 1.9 | 1.7 | 1.6 | 1.5 |

For an elastic metal multistrand rope of structure 44.35 having a diameter D=3.8 mm and a force at break Fm=9500 N, values of the spacing P of between 4.8 mm and 6.5 mm ensure that the essential features of the invention are complied with.

The inventors carried out comparative analyses of the state of the interface between the protective reinforcement and the tread for tires according to the invention and for tires of the prior art that have been driven on by customers. They found that the extent of the areas of corrosion, in particular perpendicularly to the elastic metal reinforcers of the protective layer, were significantly smaller for the tires according to the invention compared with the tires of the prior art, resulting in a significant improvement in terms of resistance of the crown to attack.

1. A tire for a heavy vehicle of construction plant type, comprising a crown reinforcement radially on the inside of a tread and radially on the outside of a carcass reinforcement,
the crown reinforcement comprising, radially from the outside to the inside, a protective reinforcement and a working reinforcement,
the protective reinforcement comprising at least one protective layer comprising metal reinforcers that are coated in an elastomeric material, are mutually parallel and form an angle at least equal to 10° with a circumferential direction tangential to the circumference of the tire,
the metal reinforcers of the protective layer each having a section of diameter D and being spaced apart in pairs by a spacing P at least equal to the diameter D,
the metal reinforcers of the protective layer being elastic and having a breaking strength Fm,
wherein the ratio A=(P−D)/D is at least equal to 0.25 and at most equal to 1, and the ratio B=(Fm/P)/1000 is at least equal to 1.1 and at most equal to 2, Fm being expressed in N and P being expressed in mm, and the elastic metal reinforcers of the protective layer are multistrand ropes of structure 1×N comprising a single layer of N strands wound in a helix, each strand comprising an internal layer of M internal threads wound in a helix and an external layer of K external threads wound in a helix around the internal layer, in that M=3.

2. The tire according to claim 1, wherein the ratio A=(P−D)/D is at least equal to 0.3.

3. The tire according to claim 1, wherein the diameter D is at least equal to 3 mm, the force at break Fm is at least equal to 5900 N, and the spacing P is at least equal to 4 mm.

4. The tire for a heavy vchicic of construction plant typc according to claim 1, wherein N=3.

5. (canceled)

6. The tire according to claim 1, wherein K=7, 8, 9, 10 or 11.

7. The tire according to claim 1, wherein the metal reinforcers of the protective layer form an angle at least equal to 15° and at most equal to 35° with the circumferential direction Ng.

8. The tire according to claim 1, wherein the protective reinforcement comprises two protective layers, the respective metal reinforcers of which are crossed from one protective layer to the next.

9. The tire according to claim 1, wherein the working reinforcement comprises two working layers, the respective metal reinforcers of which, which are inextensible, are coated in an elastomeric material, are mutually parallel and form an angle at least equal to 15° and at most equal to 45° with the circumferential direction, are crossed from one working layer to the next.

10. The tire according to claim 1, wherein the crown reinforcement comprises, radially on the inside of the working reinforcement, a hoop reinforcement comprising two hooping layers, the respective metal reinforcers of which, which are coated in an elastomeric material, are mutually parallel and form an angle at most equal to 10° with the circumferential direction, are crossed from one hooping layer to the next.

11. The tire according to claim 1, wherein N=4.

12. The tire according to claim 1, wherein K=8.
